(19) United States
(12) Patent Application Publication
(10) Pub. No.: US 2008/0213508 A1
(43) Pub. Date: Sep. 4, 2008

(54) COLOR PURITY IMPROVING SHEET, OPTICAL APPARATUS, IMAGE DISPLAY, AND LIQUID CRYSTAL DISPLAY

(75) Inventors: Megumu NAGASAWA, Ibaraki-shi (JP); Michie SAKAMOTO, Ibaraki-shi (JP); Akira OOTANI, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 12/019,180

(22) Filed: Jan. 24, 2008

(30) Foreign Application Priority Data
Jan. 25, 2007 (JP) 2007-014751

(51) Int. Cl. C09K 19/02; B32B 3/28

(52) U.S. Cl. 428/1.1; 428/142; 428/29

(57) ABSTRACT

The present invention provides a highly practicable color purity improving sheet that while preventing unevenness in color and brightness from occurring, allows light with an improved color purity to be used for an image display efficiently and can improve color reproducibility of the image display. The color purity improving sheet includes a light-emitting layer which improves the purity of a color in a target wavelength range by absorbing light in a specific wavelength range other than the target wavelength range and converts the absorbed light to emitted light in the target wavelength range. The surface of the light-emitting layer on at least the light outgoing side is roughened so as to have an arithmetic average surface roughness Ra defined in JIS B 0601 (1994 version) in the range of 0.1 to 100 μm.

### CROSS-REFERENCE TO RELATED APPLICATIONS

This application claims priority from Japanese Patent Application No. 2007-14751, filed on Jan. 25, 2007. The entire subject matter of the Japanese Patent Application is incorporated herein by reference.

### BACKGROUND OF THE INVENTION

1. Field of the Invention

The present invention relates generally to color purity improving sheets, optical apparatuses, image displays, and liquid crystal displays.

2. Description of the Related Art

Recently, a liquid crystal display in which light emitted from a light source device such as a cold cathode tube or a light emitting diode (LED) is controlled by a liquid crystal panel and images formed thereby have been studied and put into practical use. In the liquid crystal display, in order to distribute the light from the light source device over the whole display surface equally, a light guide plate is disposed on the optical path reaching the light source device and in parallel with the liquid crystal panel so as to be placed thereon. The light source device is disposed beside the light guide plate or on the side of the light guide plate opposite to the liquid crystal panel.

The configuration of a conventional liquid crystal display is shown in a sectional view in FIG. 10. As shown in FIG. 10, this liquid crystal display has a liquid crystal panel 91, a cold cathode tube 94, and a light guide plate 95 as main components. The liquid crystal panel 91 has a structure in which a first polarizing plate 931 and a second polarizing plate 932 are disposed on the opposite sides of the liquid crystal cell 92, respectively. The liquid crystal cell 92 is provided with a liquid crystal layer 940 in the center thereof. A first alignment film 951 and a second alignment film 952 are disposed on the opposite sides of the liquid crystal layer 940, respectively. A first transparent electrode 961 and a second transparent electrode 962 are disposed on the outer sides of the first alignment film 951 and the second alignment film 952, respectively. Black matrices 990 and color filters 970 of, for example, R (red), G (green), and B (blue) with a predetermined arrangement are disposed on the outer side of the first transparent electrode 961 via a protective film 980. A first substrate 901 and a second substrate 902 are disposed on the outer sides of the color filter 970 as well as black matrices 990, and the second transparent electrode 962, respectively. In the liquid crystal panel 91, the first polarizing plate 931 side is a display side, and the second polarizing plate 932 side is a back side. The light guide plate 95 is disposed in parallel with the liquid crystal panel 91 so as to be placed thereon on the back side of the liquid crystal panel 91. The cold cathode tube 94 is disposed on the side of the light guide plate 95 opposite to the liquid crystal panel 91.

In this liquid crystal display, the light emitted from the cold cathode tube 94 is adjusted with the light guide plate 95 so that the in-plane brightness distribution may become uniform, and it is then emitted to the second polarizing plate 932 side. After the outgoing light is controlled per pixel by the liquid crystal layer 940, only the light in predetermined wavelength ranges (for example, the respective wavelength ranges of R, G, and B) is transmitted through the color filters 970 and thereby a color display is obtained.

In the conventional liquid crystal display, however, colors between any two of R, G, and B (for instance, yellow light in the wavelength range between the wavelength range of R and the wavelength range of G, and light in the wavelength range between the wavelength range of G and the wavelength range of B) other than R, G, and B are mixed in the emission spectrum of a cold cathode tube, and they are not filtered out sufficiently with color filters. As a result, there has been a problem in that the color reproducibility deteriorates in the display image quality. Furthermore, when an LED corresponding to three colors of R, G, and B is used as a backlight, excellent color reproducibility is obtained, but there has been a problem in that the control circuit is complicated and higher cost is required.

Moreover, a liquid crystal display has been proposed in which white light is generated with light emitted from a blue LED and yellow light emitted from yttrium aluminum garnet (YAG), which is a fluorescent material, and is then used as a light source (see, for example, JP 2004-117594 A). In this liquid crystal display, however, the light source contains a larger quantity of light of the colors between any two of R, G, and B as compared to a cold cathode tube. Accordingly, it has a lower color reproducibility.

An optical apparatus for a liquid crystal display has been proposed as a means for solving these problems. The optical apparatus contains a fluorescent material that absorbs yellow light (light in the wavelength range between the wavelength range of R and the wavelength range of G) with a wavelength of 575 to 605 nm and emits light of R with a wavelength of at least 610 nm, and this fluorescent material converts the yellow light contained in the emission spectrum of a light source into the light of R (see JP 2005-276586 A). For this optical apparatus, a method has been proposed in which a light guide plate or a light reflector is allowed to contain the fluorescent material. Furthermore, for this optical apparatus, another method also has been proposed in which the fluorescent material is applied to the upper surface or end faces of the light guide plate or the surface of a light source.

However, in the method in which a light guide plate or a light reflector is allowed to contain the fluorescent material, there is a problem in that the fluorescent material is present in some regions and absent in other regions in the light guide plate or light reflector depending on the locations thereof, and thereby the wavelength distribution spectrum of the light emitted is not constant, which causes unevenness in color. Furthermore, in the method in which the fluorescent material is applied to, for example, the upper surface of the light guide plate, there is a problem in that in-plane unevenness in brightness occurs. Furthermore, in both those methods, the use efficiency of the light converted with the fluorescent material is not sufficiently high and the color reproducibility of the liquid crystal display cannot be considered to be sufficiently high. Moreover, the optical apparatus lacks in practicability as, for example, the configuration thereof becomes complicated.

### SUMMARY OF THE INVENTION

Accordingly, the present invention is intended to provide a highly practicable color purity improving sheet that while preventing unevenness in color and brightness from occurring, allows light with an improved color purity to be used for an image display efficiently and can improve the color reproducibility of the image display.

In order to achieve the above-mentioned object, a first color purity improving sheet of the present invention includes a light-emitting layer with a light-emitting means for improving the purity of a color in a target wavelength range by absorbing light in a specific wavelength range other than the target wavelength range and then converting its wavelength to emit light in the target wavelength range, wherein the surface of the light-emitting layer on at least a light outgoing side is roughened so as to have an arithmetic average surface roughness Ra defined in JIS B 0601 (1994 version) in the range of 0.1 to 100 μm.

A second color purity improving sheet of the present invention includes a surface-roughened layer and a light-emitting layer with a light-emitting means for improving the purity of a color in a target wavelength range by absorbing light in a specific wavelength range other than the target wavelength range and then converting its wavelength to emit light in the target wavelength range, wherein the surface of the surface-roughened layer on at least the light outgoing side is roughened so as to have an arithmetic average surface roughness Ra defined in JIS B 0601 (1994 version) in the range of 0.1 to 100 μm, and the surface-roughened layer is stacked on the light-emitting layer on the light outgoing side.

An optical apparatus of the present invention is an optical apparatus including a light source device and a color purity improving sheet, wherein the color purity improving sheet is the color purity improving sheet of the present invention.

An image display of the present invention is an image display including a color purity improving sheet, wherein the color purity improving sheet is the color purity improving sheet of the present invention.

A liquid crystal display of the present invention is a liquid crystal display including a color purity improving sheet, wherein the color purity improving sheet is the color purity improving sheet of the present invention.

The first and second color purity improving sheets of the present invention each are not provided for a component, such as a light guide plate or a light reflector, as in a conventional optical apparatus. They are independent sheets. Since the sheets of the present invention each are an independent sheet as described above, a light-emitting means can be distributed uniformly inside a sheet (a light-emitting layer). Accordingly, the sheets of the present invention can improve the color purity of light that passes therethrough while preventing unevenness in color and brightness from occurring. Furthermore, in the first and second color purity improving sheets of the present invention, the surface of the light-emitting layer or surface-roughened layer on at least the light outgoing side is roughened so that the arithmetic average surface roughness Ra is in the range of 0.1 to 100 μm. Accordingly, as described later, in the first and second color purity improving sheets of the present invention, the optical path length in the sheet can be shortened and thereby light can be prevented from attenuating. As a result, in the first and second color purity improving sheets of the present invention, light with an improved color purity obtained through the wavelength conversion can be utilized well and thereby the color reproducibility of the image display can be improved. Moreover, the use of the first or second color purity improving sheet of the present invention allows the color purity to improve by only disposing the sheet inside the liquid crystal display. They therefore have excellent practicability.

### BRIEF DESCRIPTION OF THE DRAWINGS

FIG. 1 is a cross-sectional view showing an example of the first color purity improving sheet according to the present invention.

FIG. 2 is a cross-sectional view showing another example of the first color purity improving sheet according to the present invention.

FIG. 3 is a cross-sectional view showing still another example of the first color purity improving sheet according to the present invention.

FIG. 4 is a cross-sectional view showing an example of the second color purity improving sheet according to the present invention.

FIG. 5 is a graph showing the absorption spectrum in an example of the fluorescent material to be used in the present invention.

FIGS. 6A and 6B each are a schematic view for explaining the state where light travels inside a color purity improving sheet.

FIG. 7 is a cross-sectional view showing an example of the structure of a liquid crystal display according to the present invention.

FIG. 8 is a diagram for explaining the method of measuring the emission spectrum in the examples of the present invention.

FIG. 9 is a graph showing the measurement result of the emission spectrum in the examples of the present invention.

FIG. 10 is a cross-sectional view showing an example of the structure of a conventional liquid crystal display.

### DETAILED DESCRIPTION OF THE INVENTION

In the present invention, “improvement in color purity” embraces, for example, conversion of yellow light, which is a color between R and G, into light of R or G, conversion of light of a color between G and B into light of G, and conversion of light of any of R, G, and B into light of a color other than R, G, and B.

In the first color purity improving sheet of the present invention, the surface of the light-emitting layer on at least the light outgoing side may be roughened by a process such as surface grinding, sandblasting, or embossing.

In the first color purity improving sheet of the present invention, the surface of the light-emitting layer on at least the light outgoing side may be roughened with, for example, fine particles added thereto.

In the second color purity improving sheet of the present invention, the surface-roughened layer may be, for example, a diffuser plate, a prism sheet, or a microlens array film.

In the color purity improving sheets of the present invention, it is preferable that the light-emitting means contain a fluorescent material.

In the color purity improving sheets of the present invention, it is preferable that the light-emitting layer be formed of a matrix polymer and a fluorescent material.

In the color purity improving sheets of the present invention, examples of the fluorescent material include fluoresceins, rhodamines, coumarins, dansyls (dimethylaminonaphthalenesulfonic acids), 7-nitrobenzo-2-oxa-1,3-diazol (NBD) dyes, pyrene, perylene, phycobiliprotein, cyanine pigment, anthraquinone, thioindigo, and benzopyran fluorescent materials. One of the fluorescent materials can be used individually or two or more of them can be used in combination.

In the color purity improving sheets of the present invention, it is preferable that the fluorescent material be a perylene fluorescent material.

In the color purity improving sheets of the present invention, it is preferable that the perylene fluorescent material be represented by the following structural formula (1):

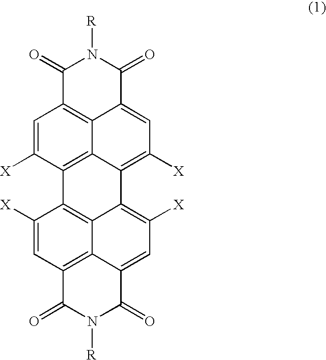

where four Xs each are a halogen group or an alkoxy group, the respective Xs can be identical to or different from one another, and two Rs each are an aryl group or an alkyl group, the respective Rs can be identical to or different from each other.

In the color purity improving sheets of the present invention, examples of the matrix polymer include polymethylmethacrylate, polyacrylic resin, polycarbonate resin, polynorbornene resin, polyvinyl alcohol resin, and cellulose resin. One of the matrix polymers may be used individually or two or more of them may be used in combination.

In the color purity improving sheets of the present invention, it is preferable that the matrix polymer be polymethylmethacrylate.

In the color purity improving sheets of the present invention, the specific wavelength range of light that is absorbed by the light-emitting layer is not particularly limited, and it can be, for example, in the range of 560 to 610 nm. On the other hand, the target wavelength range of light emitted by the light-emitting layer is not particularly limited, and it can be, for example, in the range of 610 to 700 nm.

Next, a color purity improving sheet of the present invention is described using an example.

In the present invention, the planar shape of the color purity improving sheet is an oblong figure and can be a square or a rectangle but is preferably a rectangle.

The color purity improving sheet has a light-emitting layer including the light-emitting means that improves the purity of the color in the target wavelength range by absorbing light (light of an unnecessary color) in a specific wavelength range other than the target wavelength range, converting its wavelength, and then emitting light (light of a required color) in the target wavelength range.

As described above, it is preferable that the light-emitting means contain a fluorescent material. Examples of the fluorescent material are as described above.

Specific examples of the fluorescent material include “Lumogen F Red 305 (perylene)” (trade name) manufactured by BASF AG, “Plast Red 8355 and 8365 (anthraquinone), Plast Red D-54 (thioindigo), Plast Red DR-426 and DR-427 (benzopyran)” (trade names) manufactured by Arimoto Chemical Co., Ltd., and “NK-1533 (carbocyanine dye)” (trade name) manufactured by Hayashibara Biochemical Labs., Inc. These fluorescent materials absorb yellow light (with a wavelength of 560 to 610 nm), which is a color between R and G, and emit light (with a wavelength of 610 to 650 nm) of R.

As described above, it is preferable that the perylene fluorescent material be represented by the structural formula (1). The absorption spectrum of the fluorescent material represented by the structural formula (1) is shown in the graph in FIG. 5. As shown in FIG. 5, this fluorescent material has a maximum absorption wavelength around 585 nm.

As described before, it is preferable that the light-emitting layer be formed of a matrix polymer and a fluorescent material. The light-emitting layer can be produced by, for example, mixing the above-mentioned fluorescent material with a matrix polymer that can be formed as a film and forming it into a film. The matrix polymer is preferably an organic polymer with excellent optical transparency. Examples thereof include: polyacrylic resins such as polymethylmethacrylate, polyethyl acrylate, polybutyl acrylate; polycarbonate resins such as polyoxycarbonyloxyhexamethylene and polyoxycarbonyloxy-1,4-isopropylidene-1,4-phenylene; polyvinyl alcohol resins such as polyvinyl formal, polyvinyl acetal, and polyvinyl butyral; polyester resins such as polybutylene terephthalate and polytetramethyl terephthalate; polyarylate resins such as polyamide-imide and polyetherimide; and cellulose resins such as methylcellulose, ethylcellulose, and derivatives thereof. Among them, polymethylmethacrylate is preferred. One of the matrix polymers can be used individually, or two or more of them can be used in combination.

Next, the method of forming the light-emitting layer is described using an example but is not limited to the example.

First, the matrix polymer is dissolved in a solvent and thereby a polymer solution is prepared. Examples of the solvent to be used herein include toluene, methyl ethyl ketone, cyclohexanone, ethyl acetate, ethanol, tetrahydrofuran, cyclopentanone, and water.

Next, the fluorescent material is added to and dissolved in the polymer solution. The amount of the fluorescent material to be added can be determined suitably according to the type of the fluorescent material. With respect to 100 parts by weight of the matrix polymer, it can be, for example, in the range of 0.01 to 80 parts by weight, preferably in the range of 0.1 to 50 parts by weight, and more preferably in the range of 0.1 to 30 parts by weight.

Subsequently, the polymer solution to which the fluorescent material has been added is applied onto a substrate to form a coating film, which is then dried by heating. Thus a film is formed.

Next, the film is separated from the substrate and thereby the light-emitting layer can be obtained. The thickness of the light-emitting layer is not particularly limited. It is, for example, in the range of 0.1 to 1000 μm, preferably in the range of 1 to 200 μm, and more preferably in the range of 2 to 50 μm.

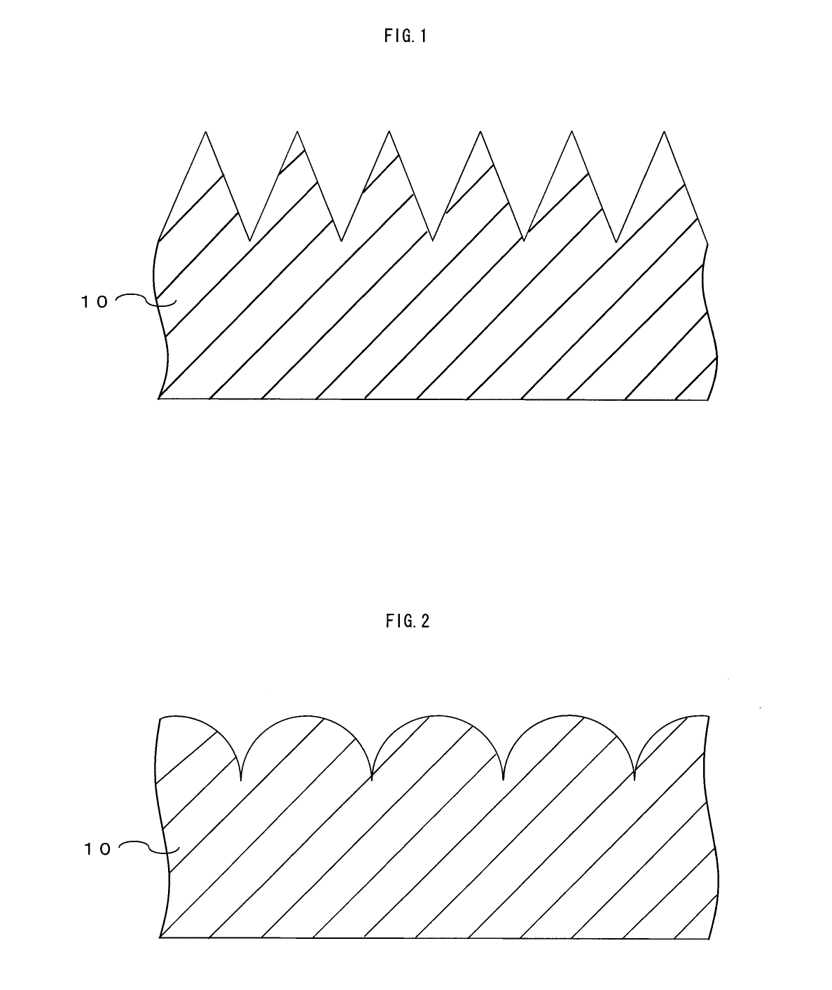

An example of the first color purity improving sheet of the present invention is shown in the cross-sectional view in FIG. 1. The color purity improving sheet of this example is a sheet composed only of the light-emitting layer. As shown in FIG. 1, this color purity improving sheet (light-emitting layer) 10 has a surface roughened on the light outgoing side (on the upper side in FIG. 1). In FIG. 1, the shape of the above-mentioned roughened surface is formed of a plurality of acute portions, but the present invention is not limited to this. For example, as shown in FIG. 2, the shape of the roughened surface may be formed of a plurality of hemispherical portions or portions with another shape. The shape of the roughened surface may be formed of a combination of two types or more of portions whose shapes are different from each other. Specifically, it may be formed of a combination of acute portions and hemispherical portions, for example. Furthermore, in this example, only the surface of the light-emitting layer on the light outgoing side is roughened, but the present invention is not limited thereto. The surface of the light-emitting layer on the light incident side may be roughened. However, from the viewpoint of effective use of light whose wavelength has been converted, it is preferable that the light-emitting layer have a roughened surface only on the light outgoing side.

The means for roughening the surface of the color purity improving sheet (light-emitting layer) 10 on at least the light outgoing side is not particularly limited. Examples thereof include a method in which a flat sheet is produced and then the surface thereof is ground and a method in which a flat sheet is produced and is then pressed with a mold having a corresponding shape. Specific examples thereof include processing in which the surface is ground with sandpaper No. 800 or lower number, sandblast processing, and emboss processing.

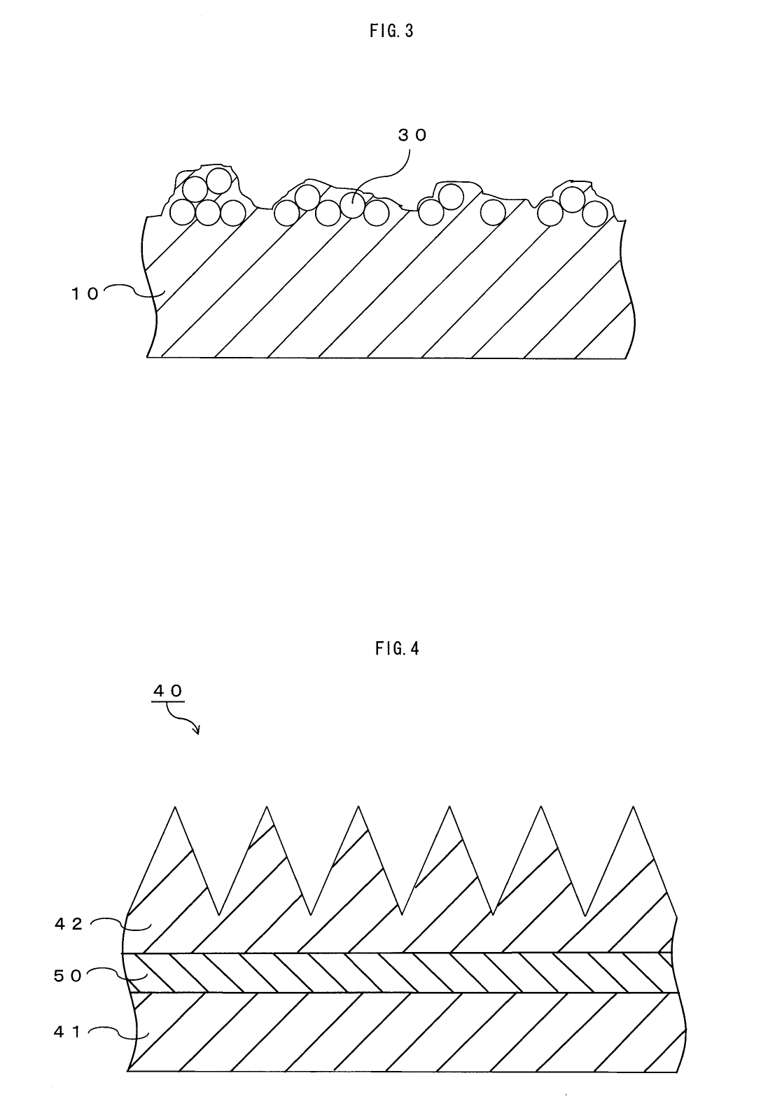

It also is possible to roughen the surface of the light-emitting layer on at least the light outgoing side by kneading fine particles in the polymer solution containing the fluorescent material added thereto. An example of the color purity improving sheet of the present invention in which fine particles have been kneaded is shown in the cross-sectional view in FIG. 3. The color purity improving sheet of this example also is a sheet composed only of the light-emitting layer. As shown in FIG. 3, since the color purity improving sheet (light-emitting layer) 10 contains fine particles 30 that have been kneaded therein, the surface on the light outgoing side (the upper side in FIG. 3) has been roughened.

The fine particles 30 may be, for instance, inorganic fine particles or organic fine particles. The inorganic fine particles are preferably, for example, metal oxide, metal nitride, metal sulfide, or metal halide, and more preferably metal oxide. The above-mentioned metal atom is preferably Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, or Pb, and more preferably Mg, Ca, B, or Si. The above-mentioned metal compound may consist of one type of the aforementioned metal atom or may contain two or more types of the metal atoms described above. Specifically, examples of the inorganic fine particles include silicon dioxide (SiO₂), titanium dioxide, tin dioxide, zinc dioxide, and indium oxide, and particularly preferable inorganic fine particles are silicon dioxide (SiO₂). Examples of the organic fine particles include polymethylmethacrylate powder (PMMA fine particles), silicone resin powder, polystyrene resin powder, polycarbonate resin powder, acrylic styrene resin powder, benzoguanamine resin powder, melamine resin powder, polyolefin resin powder, polyester resin powder, polyamide resin powder, polyimide resin powder, and the polyfluoroethylene resin powder. One of the inorganic and organic fine particles described above may be used individually or two or more of them may be used in combination.

The arithmetic average surface roughness Ra of the surface of the color purity improving sheet (light-emitting layer) 10 on at least the light outgoing side is in the range of 0.1 to 100 μm. The arithmetic average surface roughness Ra set at 0.1 μm or more allows the optical path length in the sheet to be shorter, light whose wavelength has been converted to be prevented from attenuating, and thereby the conversion efficiency to be improved as described later. Furthermore, when the Ra is set at 0.1 μm or more, it also is possible to avoid deterioration in visibility at the display surface that is caused by the rainbow pattern due to moire interference. Moreover, when the Ra is set at 100 μm or less, the glaring effect of reflected light can be reduced and it therefore is no longer necessary to increase the thickness of the sheet. The arithmetic average surface roughness Ra is preferably in the range of 0.1 to 80 μm and more preferably in the range of 0.1 to 70 μm.

The arithmetic average surface roughness Ra also is called “the arithmetic average roughness Ra”, is one of the indices that indicate roughness of the surface of an object, and is defined in JIS B 0601 (1994 version). The arithmetic average surface roughness Ra can be measured by, for example, the method described later in the section of Examples. In the present invention, the description in this specification allows any persons skilled in the art to obtain the above-mentioned range of the arithmetic average surface roughness Ra easily. For example, the range of the arithmetic average surface roughness Ra can be obtained easily by suitably selecting the type (for instance, roughness) of sandpaper or the number of times or intensity of rubbing with sandpaper.

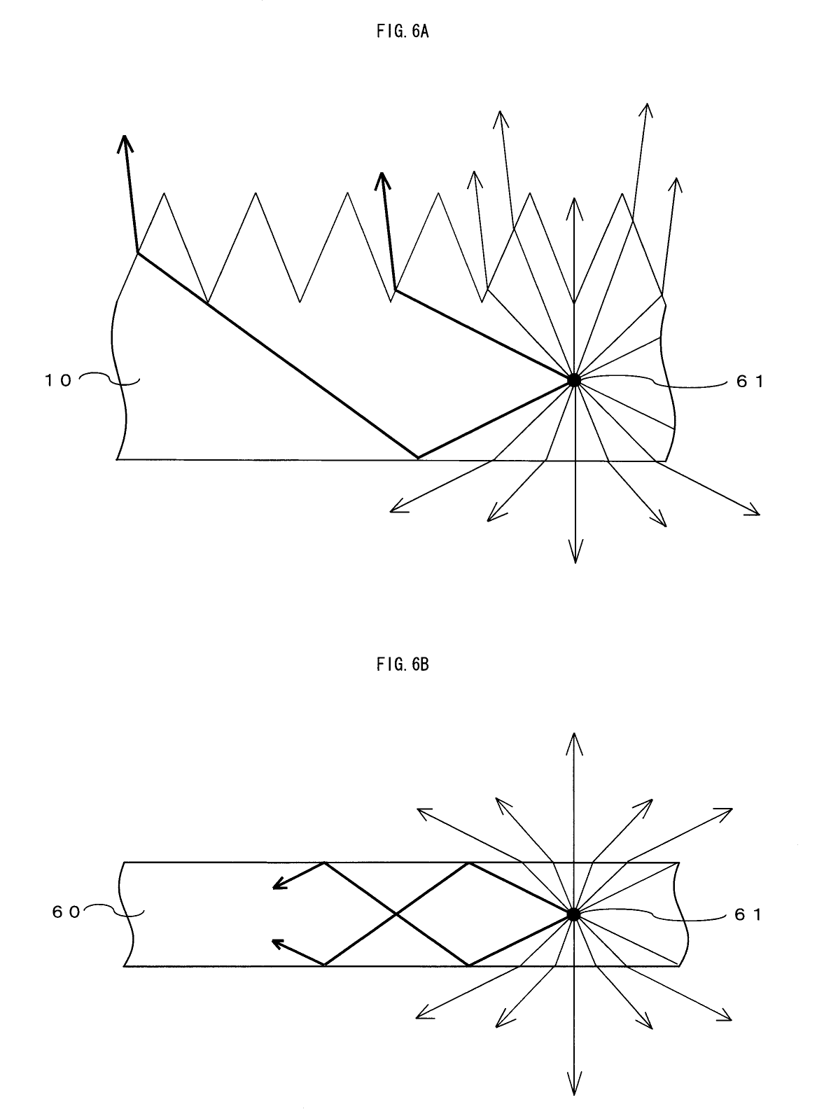

Next, a mechanism is described in which the optical path length in the sheet of the light with color purity improved with the fluorescent material is shortened by roughening the surface of the color purity improving sheet (light-emitting layer) 10 on at least the light outgoing side. FIGS. 6A and 6B each schematically shows the state of light traveling inside the color purity improving sheet. In FIGS. 6A and 6B, the arrows indicate paths of light (optical paths). FIG. 6A shows an example in which the surface of the color purity improving sheet on the light outgoing side (the upper side in FIG. 6A) has been roughened. FIG. 6B shows an example in which both surfaces are not roughened. In FIG. 6B, as shown with thick arrows, in the color purity improving sheet 60 whose surfaces both are not roughened, the light whose wavelength has been converted by the fluorescent material 61 repeats total reflection at the interfaces between the sheet and the air and continues to stay inside the sheet. On the other hand, in FIG. 6A, many portions having larger light incident angles at the surface on the light outgoing side are formed in the color purity improving sheet 10 having a roughened surface on the light outgoing side (the upper side in FIG. 6A). Accordingly, as shown with thick arrows in FIG. 6A, the light whose wavelength has been converted with the fluorescent material 61 goes out of the sheet without being reflected or goes out of the sheet after being reflected once or so. Thus, when the surface of the color purity improving sheet 10 on at least the light outgoing side is roughened, the optical path length in the sheet of the light whose color purity has been improved with the fluorescent material is shortened and as a result, the light whose color purity has been improved can be used efficiently.

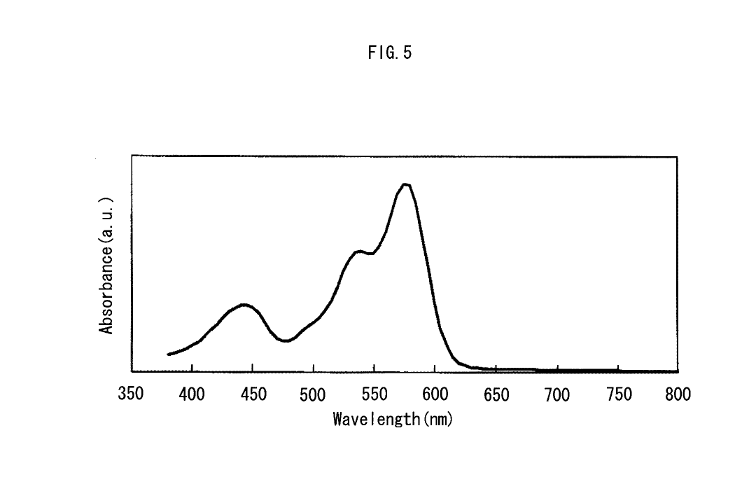

The color purity improving sheet of the present invention does not always need to have a single-layer structure. An example of the second color purity improving sheet according to the present invention is shown in the cross-sectional view in FIG. 4. As shown in FIG. 4, this color purity improving sheet 40 has a three-layer structure in which a surface-roughened layer 42 whose surface on the light outgoing side (the upper side in FIG. 4) has been roughened is stacked above a flat light-emitting layer 41 on the light outgoing side thereof, with an adhesive layer 50 being interposed therebetween. The flat light-emitting layer 41 can be produced in the same manner as in the case of the color purity improving sheet (light-emitting layer) 10 except that it is not subjected to the roughening process. Examples of the surface-roughened layer 42 to be used include a commercial diffuser plate, prism sheet, and microlens array film. Examples of the adhesive layer 50 to be used include acrylic adhesives, polyurethane adhesives, epoxy adhesives, and polyethylenimine adhesives. The flat light-emitting layer 41 and the surface-roughened layer 42 may be bonded thermally together without using the adhesive layer 50.

The average thickness of the surface-roughened layer 42 is not particularly limited and is, for example, in the range of 1 to 60 μm, preferably in the range of 2 to 50 μm, and more preferably in the range of 3 to 50 μm. The thickness of the adhesives layer 50 also is not particularly limited and is, for example, in the range of 0.1 to 30 μm, preferably in the range of 0.2 to 25 μm, and more preferably in the range of 0.3 to 20 μm.

The optical apparatus of the present invention has a configuration including a light source device and the color purity improving sheet of the present invention. In the optical apparatus of the present invention, the color purity improving sheet of the present invention is disposed, with the roughened surface being located on the opposite side to the light source device.

The light source device is not particularly limited. Examples thereof include a cold cathode tube and a light emitting diode (LED).

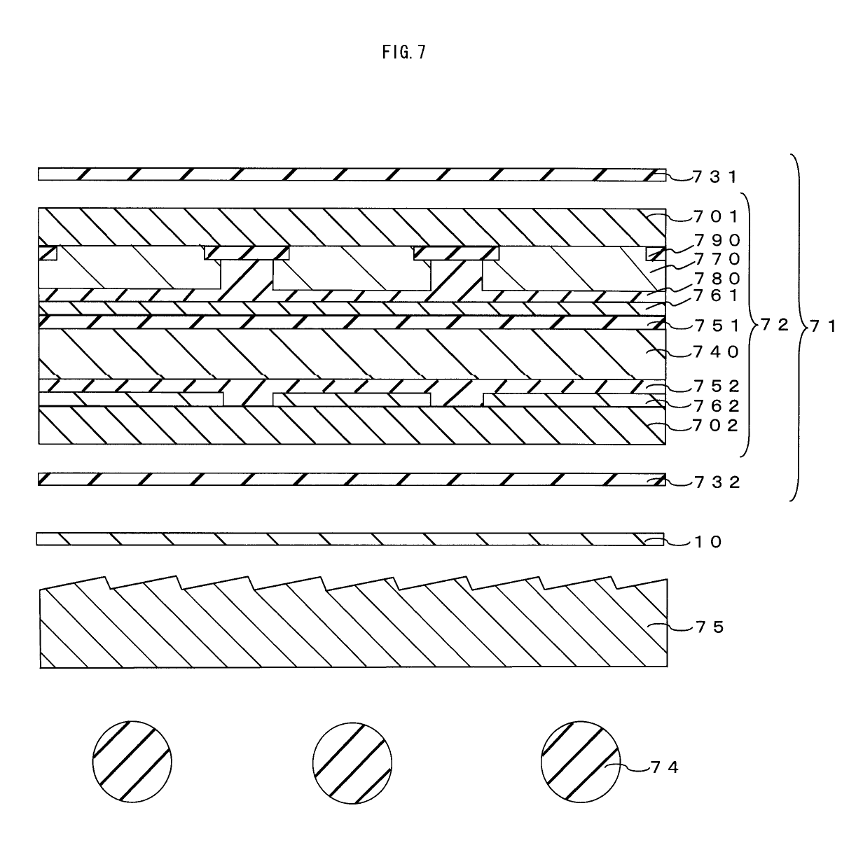

The color purity improving sheet of the present invention can be used suitably for various types of image displays, such as a liquid crystal display (LCD) and an EL display (ELD). An example of the configuration of the liquid crystal display according to the present invention is shown in the cross-sectional view in FIG. 7. In FIG. 7, in order to make it clearly understandable, for example, the sizes and ratios of respective components differ from actual ones. As shown in FIG. 7, this liquid crystal display includes a liquid crystal panel 71, a color purity improving sheet 10 of the present invention, a light source device 74, and a light guide plate 75 as main components. The liquid crystal panel 71 is configured with a first polarizing plate 731 and a second polarizing plate 732 disposed on the respective sides of a liquid crystal cell 72. The liquid crystal cell 72 is provided with a liquid crystal layer 740 in the center thereof. A first alignment film 751 and a second alignment film 752 are disposed on the sides of the liquid crystal layer 740, respectively. A first transparent electrode 761 and a second transparent electrode 762 are disposed on the outer sides of the first alignment film 751 and the second alignment film 752, respectively. Color filters 770 with a predetermined arrangement of, for example, R, G, and B, and black matrices 790 are disposed via a protective film 780 on the outer side of the first transparent electrode 761. A first substrate 701 and a second substrate 702 are disposed on the outer sides of the color filters 770 as well as the black matrices 790, and the second transparent electrode 762, respectively. In the liquid crystal panel 71, the first polarizing plate 731 side is a display side, and the second polarizing plate 732 side is the back side. The color purity improving sheet 10 of the present invention is disposed on the back side of the liquid crystal panel 71, with the roughened surface (the surface on the light outgoing side) being located on the liquid crystal panel 71 side. The light guide plate 75 is disposed, on the outer side of the color purity improving sheet 10 of the present invention, in parallel with the liquid crystal panel 71 to lie on top thereof. The light source device 74 is disposed on the side of the light guide plate 75 opposite to the liquid crystal panel 71. In FIG. 7, although the color purity improving sheet 10 of the present invention is disposed between the liquid crystal panel 71 and the light guide plate 75, the color purity improving sheet 10 of the present invention may be disposed between the light guide plate 75 and the light source device 74. With the liquid crystal display of this example, the case is illustrated where the direct type is employed in which the light source device 74 is disposed directly under the liquid crystal panel 71 via the color purity improving sheet 10 of the present invention and the light guide plate 75. However, the present invention is not limited thereto and it may employ, for example, a side light type.

In the liquid crystal display of this example, improvement in color purity is carried out, for example, as follows. For instance, assume that, for example, a member that has high emission peaks of B, G, and R around 435 nm, 545 nm, and 610 nm, respectively, is used for the light source device 74, the liquid crystal display uses only the emission of G and R, and the emission of yellow (around 585 nm) that is a color between G and R is not required. In this case, the color purity improving sheet 10 of the present invention is allowed to contain, for instance, a fluorescent material that has a maximal absorption wavelength around 585 nm and emits light with a wavelength of 610 nm or longer. In this case, the yellow light will be absorbed by the fluorescent material, and light of R with a wavelength of 610 nm or longer will be emitted. Accordingly, the color purity of the light emitted from the light source device 74 improves. The color purity improving sheet 10 of the present invention is not provided for a structural member such as a light guide plate or a light reflector, as in the conventional optical apparatus. It is an independent sheet. Thus, when an independent sheet containing a fluorescent material is employed as the color purity improving sheet 10 of the present invention, the fluorescent material can be distributed uniformly in the sheet and thereby unevenness in color and brightness is prevented from occurring. Furthermore, as described above, in the color purity improving sheet 10 of the present invention, the surface on at least the light outgoing side is roughened so that the arithmetic average surface roughness Ra is in the range of 0.1 to 100 μm. Thus, the optical path length in the sheet can be shortened and the conversion efficiency improves.

The image display of the present invention is used for any suitable applications. Examples of the applications include office equipment such as a desktop PC, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio, display equipment such as an information monitor for stores, security equipment such as a surveillance monitor, and care and medical equipment such as a monitor for health care and a monitor for medical use.

### EXAMPLES

Next, examples of the present invention are described together with comparative examples. The present invention is neither limited nor restricted by the following examples or comparative examples. Measurement and evaluation of various characteristics and physical properties in the respective examples and comparative examples were carried out by the following methods. In each example and comparative example, only the light of R was required and light of the other colors was not required.

### (1) Arithmetic Average Surface Roughness Ra

The surface shape of the color purity improving sheet was measured using a high precision microfigure measuring instrument (manufactured by Kosaka Laboratory Ltd., “SURFCORDER ET4000” (trade name)), and then the arithmetic average surface roughness Ra defined in JIS B 0601 (1994 version) was determined. The high precision microfigure measuring instrument computes the arithmetic average surface roughness Ra automatically.

### (2) Conversion Efficiency

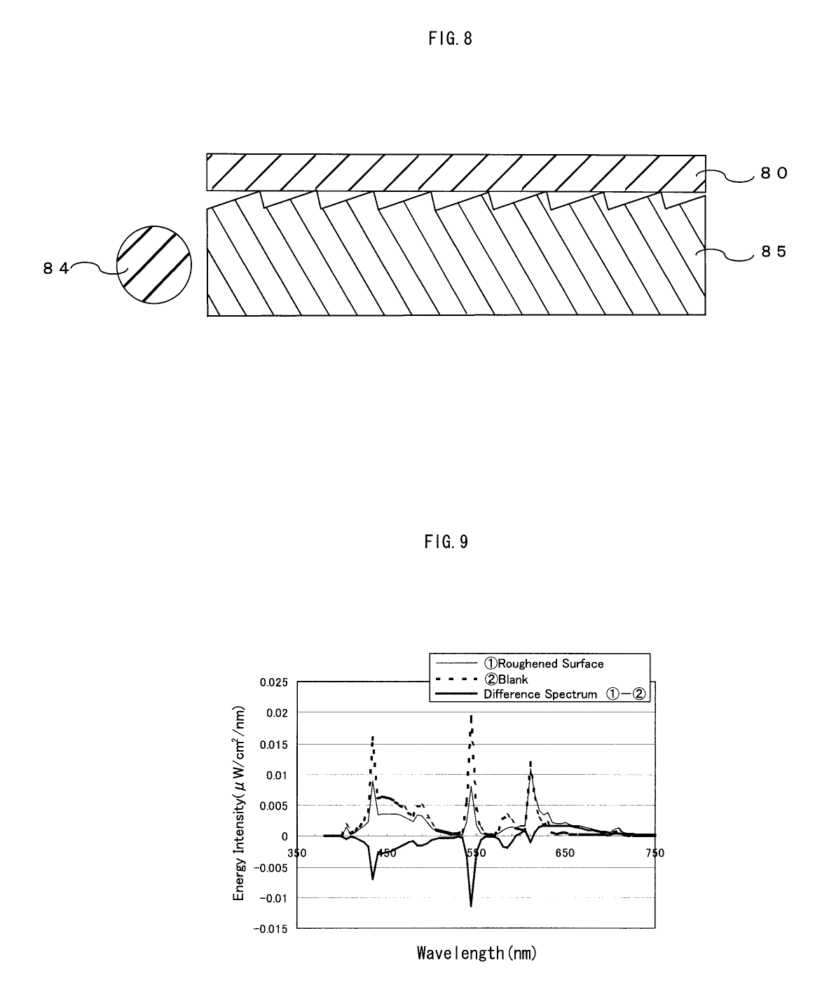

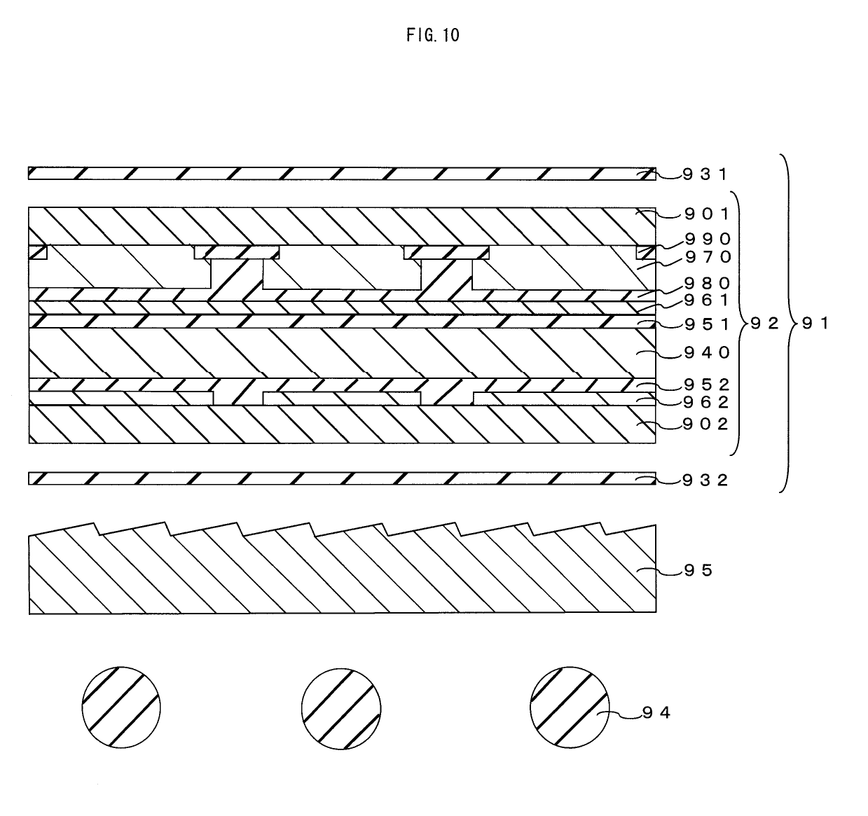

As shown in FIG. 8, the color purity improving sheet 80 was placed on a light guide plate 85 connected to a cold cathode tube 84. The cold cathode tube 84 was allowed to emit light, outgoing light from the outermost surface (the upper surface shown in FIG. 8) was collected with an integrating sphere being attached thereto, and thereby the emission spectrum was measured. For a blank, a polymethylmethacrylate film that had not been subjected to the surface grinding process was used instead of the color purity improving sheet and thereby the emission spectrum was measured. The latter data was deducted from the former spectrum data per wavelength and thereby the difference spectra were determined. The value obtained by dividing the area where the values of the difference spectra were positive by the area where the values of the difference spectra were negative was taken as the conversion efficiency.

### Example 1

### Production of Color Purity Improving Sheet

A fluorescent material (manufactured by BASF A.G., “Lumogen F Red 305” (trade name)) having the structure represented by Formula (1) above was added to and dissolved in a 30% by weight toluene solution of polymethylmethacrylate so as to be 0.19% by weight with respect to polymethylmethacrylate. This solution was applied onto a polyethylene terephthalate (PET) film base with an applicator to form a coating film, which was then dried at 80° C. for 30 minutes. Thus a film was obtained. After being dried, the film was separated from the PET film base and thereby a 30-μm thick polymethylmethacrylate film was obtained. One surface (the surface on the light outgoing side) of the film obtained above was subjected to a surface grinding process using a sandpaper (#100), so that the color purity improving sheet of this example was obtained. The surface located on the light outgoing side of the color purity improving sheet had an arithmetic average surface roughness Ra of 0.8 μm.

### Example 2

A color purity improving sheet of this example was obtained in the same manner as in Example 1 except that the surface grinding process was performed using a sandpaper (#700). The surface located on the light outgoing side of the color purity improving sheet had an arithmetic average surface roughness Ra of 0.13 μm.

### Example 3

A color purity improving sheet of this example was obtained in the same manner as in Example 1 except that the surface grinding process was performed using a sandpaper (#800). The surface located on the light outgoing side of the color purity improving sheet had an arithmetic average surface roughness Ra of 0.15 μm.

### Comparative Example 1

A color purity improving sheet of this comparative example was obtained in the same manner as in Example 1 except that the surface grinding process was performed using a sandpaper (#2000). The surface located on the light outgoing side of the color purity improving sheet had an arithmetic average surface roughness Ra of 0.05 μm.

### Comparative Example 2

A color purity improving sheet of this comparative example was obtained in the same manner as in Example 1 except that the surface grinding process was performed using a sandpaper (#2200). The surface located on the light outgoing side of the color purity improving sheet had an arithmetic average surface roughness Ra of 0.03 μm.

### Comparative Example 3

A color purity improving sheet of this comparative example was obtained in the same manner as in Example 1 except that the surface grinding process was performed using a sandpaper (#2300). The surface located on the light outgoing side of the color purity improving sheet had an arithmetic average surface roughness Ra of 0.02 μm.

Table 1 below indicates the results of evaluation of the conversion efficiency of the respective examples and comparative examples. The emission spectrum and the difference spectrum of Example 1 are shown in the graph in FIG. 9.

TABLE 1

| | Sandpaper | Light outgoing side | Conversion |
|---|---|---|---|
| | (#) | surface Ra (μm) | efficiency (%) |
| Example 1 | 100 | 0.8 | 43 |
| Example 2 | 700 | 0.13 | 40 |
| Example 3 | 800 | 0.15 | 40 |
| Comparative | 2000 | 0.05 | 30 |
| Example 1 | | | |
| Comparative | 2200 | 0.03 | 31 |
| Example 2 | | | |
| Comparative | 2300 | 0.02 | 31 |
| Example 3 | | | |

As can be seen from Table 1 above, Examples 1 to 3 had higher conversion efficiencies as compared to Comparative examples 1 to 3. As can be seen from FIG. 9, in Example 1, emission of light of colors other than R with wavelengths of 610 nm or shorter was prevented while emission of light of R with a wavelength of at least 610 nm increased.

As described above, while preventing unevenness in color and brightness from occurring, the color purity improving sheet of the present invention allows light with an improved color purity to be used for an image display efficiently and can improve the color reproducibility of the image display. Examples of the applications of the color purity improving sheet of the present invention and image displays using the same include office equipment such as a desktop PC, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio, display equipment such as an information monitor for stores, security equipment such as a surveillance monitor, and care and medical equipment such as a monitor for health care and a monitor for medical use. However, the applications thereof are not limited and they are applicable to a wide range of fields.

The invention may be embodied in other forms without departing from the spirit or essential characteristics thereof. The Examples disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color purity improving sheet, comprising a light-emitting layer which improves purity of a color in a target wavelength range by absorbing light in a specific wavelength range other than the target wavelength range and converts the absorbed light to emitted light in the target wavelength range,
wherein the surface of the light-emitting layer on at least a light outgoing side is roughened so as to have an arithmetic average surface roughness Ra defined in JIS B 0601 (1994 version) in a range of 0.1 to 100 μm.

2. The color purity improving sheet according to claim 1, wherein the surface of the light-emitting layer on at least the light outgoing side is roughened by at least one method selected from the group consisting of surface grinding, sandblasting, or embossing.

3. The color purity improving sheet according to claim 1, wherein the surface of the light-emitting layer on at least the light outgoing side is roughened with fine particles added thereto.

4. A color purity improving sheet, comprising a surface-roughened layer and a light-emitting layer which improves purity of a color in a target wavelength range by absorbing light in a specific wavelength range other than the target wavelength range and then converts the absorbed light to emitted in the target wavelength range,
wherein the surface of the surface-roughened layer on at least a light outgoing side is roughened so as to have an arithmetic average surface roughness Ra defined in JIS B 0601 (1994 version) in a range of 0.1 to 100 μm, and
the surface-roughened layer is stacked on the light-emitting layer on the light outgoing side.

5. The color purity improving sheet according to claim 4, wherein the surface-roughened layer is at least one selected from the group consisting of a diffuser plate, a prism sheet, or a microlens array film.

6. The color purity improving sheet according to claim 1, wherein the light-emitting layer contains a fluorescent material.

7. The color purity improving sheet according to claim 1, wherein the light-emitting layer is formed of a matrix polymer and a fluorescent material.

8. The color purity improving sheet according to claim 7, wherein the fluorescent material is at least one selected from the group consisting of fluoresceins, rhodamines, coumarins, dansyls, 7-nitrobenzo-2-oxa-1,3-diazole pigments, pyrene, perylenes, phycobiliproteins, cyanine pigments, anthraquinones, thioindigoes, and benzopyrans.

9. The color purity improving sheet according to claim 8, wherein the fluorescent material is a perylene fluorescent material.

10. The color purity improving sheet according to claim 9, wherein the perylene fluorescent material is represented by the following structural formula (1): 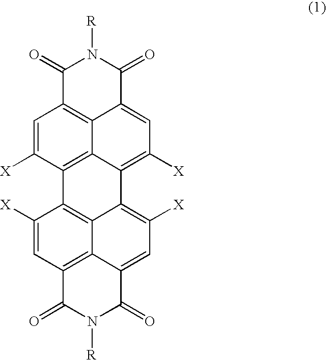
where four Xs each are a halogen group or an alkoxy group, the respective Xs can be identical to or different from one another, and two Rs each are an aryl group or an alkyl group, the respective Rs can be identical to or different from each other.

11. The color purity improving sheet according to claim 7, wherein the matrix polymer is at least one selected from the group consisting of polymethylmethacrylate, polyacrylic resin, polycarbonate resin, polynorbornene resin, polyvinyl alcohol resin, and cellulose resin.

12. The color purity improving sheet according to claim 11, wherein the matrix polymer is polymethylmethacrylate.

13. An optical apparatus comprising a light source device and a color purity improving sheet, wherein the color purity improving sheet is a color purity improving sheet according to claim 1.

14. An image display comprising a color purity improving sheet, wherein the color purity improving sheet is a color purity improving sheet according to claim 1.

15. A liquid crystal display comprising a color purity improving sheet, wherein the color purity improving sheet is a color purity improving sheet according to claim 1.

16. The color purity improving sheet according to claim 4, wherein the light-emitting means contains a fluorescent material.

17. The color purity improving sheet according to claim 4, wherein the light-emitting layer is formed of a matrix polymer and a fluorescent material.

18. The color purity improving sheet according to claim 17, wherein the fluorescent material is at least one selected from the group consisting of fluoresceins, rhodamines, coumarins, dansyls, 7-nitrobenzo-2-oxa-1,3-diazole pigments, pyrene, perylenes, phycobiliproteins, cyanine pigments, anthraquinones, thioindigoes, and benzopyrans.

19. The color purity improving sheet according to claim 18, wherein the fluorescent material is a perylene fluorescent material.

20. The color purity improving sheet according to claim 19, wherein the perylene fluorescent material is represented by the following structural formula (1): 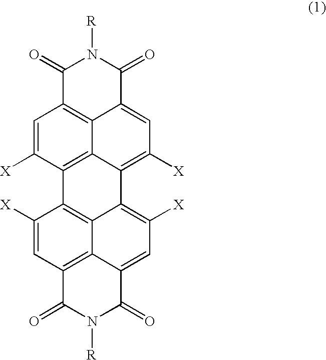
where four Xs each are a halogen group or an alkoxy group, the respective Xs can be identical to or different from one another, and two Rs each are an aryl group or an alkyl group, the respective Rs can be identical to or different from each other.

21. The color purity improving sheet according to claim 17, wherein the matrix polymer is at least one selected from the group consisting of polymethylmethacrylate, polyacrylic resin, polycarbonate resin, polynorbornene resin, polyvinyl alcohol resin, and cellulose resin.

22. The color purity improving sheet according to claim 21, wherein the matrix polymer is polymethylmethacrylate.

23. An optical apparatus comprising a light source device and a color purity improving sheet, wherein the color purity improving sheet is a color purity improving sheet according to claim 4.

24. An image display comprising a color purity improving sheet, wherein the color purity improving sheet is a color purity improving sheet according to claim 4.

25. A liquid crystal display comprising a color purity improving sheet, wherein the color purity improving sheet is a color purity improving sheet according to claim 4.
